(19) United States
(12) Patent Application Publication
(10) Pub. No.: US 2006/0143008 A1
(43) Pub. Date: Jun. 29, 2006

(54) Generation and deletion of pronunciation variations in order to reduce the word error rate in speech recognition

(76) Inventors: Tobias Schneider, MOERS (DE); Andreas Schroer, Munchen (DE); Gunter Michael Steinmabl, Verstorben (DE); Karl Steinmabl, Wolfratshausen (DE); Brigitte Steinmabl, Winibaldstrabe 41 (DE); Michael Wandinger, Munchen (DE)

Correspondence Address: BELL, BOYD & LLOYD, LLC, P. O. BOX 1135, CHICAGO, IL, 60690-1135, US

(21) Appl. No.: 10/544,596

(22) PCT Filed: Jan. 22, 2004
(86) PCT No.: PCT/EP04/00527

§ 371 Date: Aug. 4, 2005

(30) Foreign Application Priority Data
Feb. 4, 2003 (DE) 103 04 460.4

(51) Int. Cl. G10L 15/04

(52) U.S. Cl. 704/251

(57) ABSTRACT

Disclosed is a speech recognition method which is based on a dynamic extension of the word models in combination with an evaluation of the pronunciation variations.

### FIELD OF TECHNOLOGY

The present disclosure relates to phoneme-based speech recognition, and particularly to adaptable speech recognition configurations that have reduced error rates.

### BACKGROUND

In phoneme-based speech recognition, the corresponding phoneme sequences must be known for all words belonging to the vocabulary. These phoneme sequences are entered into the vocabulary. During the actual recognition process a search is then conducted in what is known as the Viterbi algorithm for the best path through the given phoneme sequences which correspond to the words. If simple single word recognition does not take place, likelihoods of transitions between the words can be modeled and included in the Viterbi algorithm.

A problem often arises in the detection of spoken expressions which deviate from the canonic phonetic transcription of a word which is usually used in the vocabulary, or differ discriminatively from the expressions which were used as a basis during the training of a word model.

These types of expressions can no longer be correctly classified by existing models and the result is an incorrect recognition. The causes of these differences are to be found, inter alia in the specific accent of the speaker as well as in the relevant pronunciation of the expression, which can be spoken quickly, indistinctly, or very slowly for example. Stationary and impulsive disturbance noises can also lead to an incorrect classification.

Furthermore, technical systems, especially systems on what are known as embedded platforms, such as those found in mobile telephones, are subject to a restriction in resources which affects the size or the capability of the modelling.

Many application scenarios in speech recognition are based on an expansion of the word models in the speech recognizer or on the adaptation of word models already present in the speech recognizer.

In the so-called “Sayln system,” the process of saying an expression (enrollment) generates a new word model. A second enrollment provides the speech recognizer with two different pronunciation variants for the classification of a word. This reduces the word error rate since the discriminative differences are captured better.

With the so-called “Typeln system, ” the phonetic model is deduced from predefined rules or through statistical approaches to the orthographic notation. Since a written word is also pronounced differently in different languages, a number of pronunciation variants can be generated in the vocabulary for a word in each case. Numerous methods of creating pronunciation variants also exist in literature. The multiplicity of pronunciation variants in its turn reduces the word error rate.

However, the common factor in these methods is that, at the time of modeling, it is not known which of the pronunciation variants are relevant for an individual user for the recognition. This is especially true for Typeln systems since the accent of speaker is not taken into consideration.

To reduce the word error rate, speech recognition systems are adapted to their relevant users. In the adaptation of word models, transformation, for example Maximum Likelihood Linear Regression (MLLR), or model parameter prediction, for example Regression Model Prediction (RMP) or Maximum A Posteriori Prediction (MAP), are used to adapt the acoustic modeling of the characteristic space underlying the word models which is present for example as a Hidden-Markov-Model (HMM). This achieves a system status which is closely adapted to the relevant user. Other users on the other hand are no longer adequately well detected in such a system.

The speech recognizer is thus changed here from a speaker-independent to a speaker-dependent system.

### BRIEF SUMMARY

Normally the complexity, which means the memory space usage, increases with the number of possible words in the speech recognizer. With embedded systems there is often only a very limited amount of memory available which is not fully utilized with a small number of words in the speech recognizer.

Accordingly, a speech recognition configuration is disclosed having a reduced word error rate which is adaptable and only consumes a very small amount of resources.

Under an exemplary embodiment, a number of pronunciation variants for a word to be recognized are stored in the memory of a device. Under an alternate embodiment, these pronunciation variants can however also be generated and added to the vocabulary. For each recognition process, the pronunciation variant of the word which was recognized is registered. After a number of recognition processes, an evaluation of the pronunciation variants is then undertaken on the basis of how often the pronunciation variants were recognized in each case.

The frequency of the detection is included under the exemplary embodiment as the simplest criterion which consumes the fewest resources. Naturally more complicated evaluation methods are possible, where the degree of correspondence between the expression to be detected and the pronunciation variant recognized in each case is taken into account.

The disclosed method can work with existing words stored in the vocabulary. However the method can be improved further if, the word models are dynamically expanded. This is done, on addition of a new word to the vocabulary, by automatically generating a number of pronunciation variants of the new word and also adding them to the vocabulary.

A number of pronunciation variants for a word can be generated, for example by phoneme replacement, phoneme deletion and/or phoneme insertion.

In the case of country-independent speech recognizers, it can also be advantageous for the pronunciation variants to be generated for different languages.

In the case of a Sayln system pronunciation variants can be generated by the addition of noise to the spoken signal (signal in the wider sense, i.e. language, feature, phoneme chain).

As an extension however, alternatively or additionally, for recognition on the basis of an expression, a further pronunciation variant for the spoken word can be generated from this expression.

Accordingly, an efficient use of the available memory can be achieved, if, for a number of words, a maximum number of pronunciation variants is generated in each case.

A further aspect of the disclosed method relates to the evaluation of the pronunciation variants.

The method advantageously enables memory space to be saved, if, as a result of the evaluation of the pronunciation variants, the number of stored pronunciation variants is reduced. This can be achieved for example by less frequently recognized pronunciation variants being deleted.

Preferably in this case those pronunciation variants are deleted for which the confidence is below a threshold value.

The speech recognizer can however in this case still be kept independent of the speaker if the additional condition is imposed that the canonic pronunciation variant of the word is never deleted.

Also, a device which is set up to execute the method described above can be implemented by the provision of means by which one or more procedural steps can be executed in each case. Advantageous embodiments of the device are produced in a similar way to the advantageous embodiments of the method.

Furthermore, a computer program product for a data processing system which contains code sections with which one of the methods described can be executed on the data processing system, can be executed through suitable implementation of the method in a programming language and compilation into code which can be executed by the data processing system. The sections are stored for this purpose. In this case a computer program product is taken to mean the program as a marketable product. It can be available in any form, for example on paper, on a computer-readable data medium or distributed over a network.

### BRIEF DESCRIPTION OF THE DRAWINGS

The various objects, advantages and novel features of the present disclosure will be more readily apprehended from the following Detailed Description when read in conjunction with the enclosed drawings, in which:

FIG. 1 illustrates a speech recognition process under an exemplary embodiment.

### DETAILED DESCRIPTION

The disclosed method is based on a dynamic expansion of the word model in combination with an evaluation of the pronunciation variants.

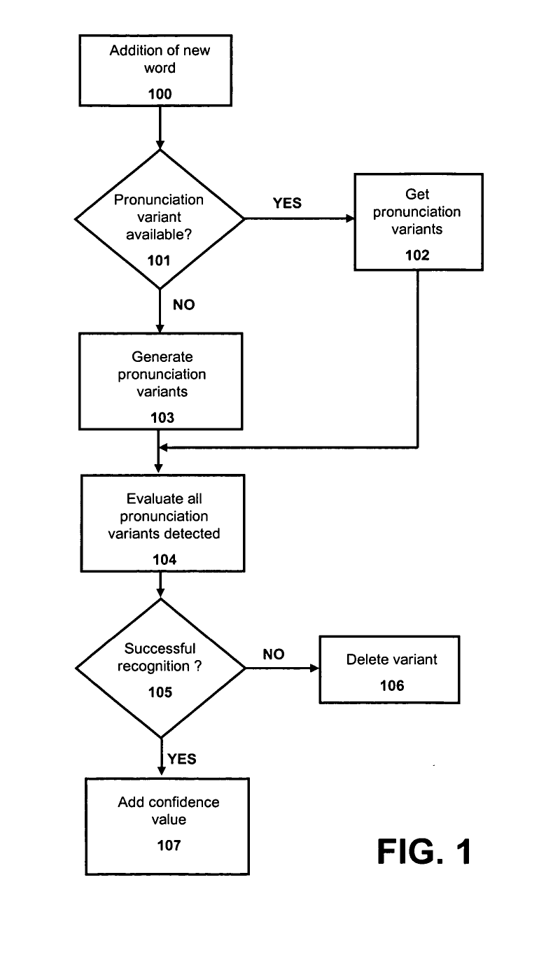

Turning to FIG. 1, an addition of a new word 100 a number of pronunciation variants of this word are generated simultaneously for the recognition vocabulary which are also added to the vocabulary 101. These variants each differ phonetically and can, depending on the technology used be created in different ways. If the variant was previously available, the variant is retrieved 102 and set for processing.

In the embodiment of FIG. 1, the amount of memory available for the pronunciation variants is preferably utilized to the optimum in that a maximum number of variants is created.

For each recognition, as well as the actual classification of the models, an evaluation of all pronunciation variants is undertaken 104. On successful recognition 105, that is if no error is detected, these confidences are added 107 in each case to confidences already obtained from a previous recognition runs of the pronunciation variants, a simple “boolean” confidence is in this case the value 1 if the pronunciation variant was referenced for this recognition, the value 0 for all other variants. An incorrect recognition can be determined from the reaction of the user among other things: For example the recognition is repeated or a command initiated by voice is aborted.

As an expansion a further pronunciation variant for the word spoken can be generated during recognition as a result of the expression. This again ensures that there is no incorrect recognition This step can also be undertaken without the user noticing it.

The accumulated confidences created on recognition for each pronunciation variant are now used to reduce the vocabulary again at a given point in time. This is done by deleting those vocabulary entries for which the accumulated confidence lies below a specific threshold 106. These entries are in general pronunciation variants which were never referenced at all or referenced very seldom and are thus not relevant for the recognition run.

The deletion of the pronunciation variants 106 means that there is now further free memory space available for new words in the vocabulary.

Unlike the prior art, the adaptation is not undertaken at the modelling level (for example HMM). Instead the adaptation is achieved by selecting one or more speech variants. This selection is in this case dependent on the referencing in the successful recognition runs. In this case the memory space available is utilized to the optimum independently of the number of words to be recognized.

If, for example with Typeln, the original canonic pronunciation variants continue to be retained in the vocabulary independence from the speaker continues to be guaranteed. If the system is used by a number of users the adaptation is for all users since on average the frequently referenced pronunciation variables of all speakers are retained.

An advantage over other methods of adaptation is that the original system behavior can be restored at any time since the HMM, that is the acoustic modelling of the feature space, remains unaffected. No further information is required for adaptation, for example the assignment of the states to features. This means that the method can be executed without any great additional code and memory overhead and is thereby also suitable for the embedded area.

The deletion of the pronunciation variants 106 increases the reliability of the recognition or referencing since the relevant entries, that is the adapted models, are generally easier to distinguish by discrimination. Simultaneously the detection is speeded up since the vocabulary is smaller.

In a phoneme-based speech-recognition system, for example an HMM recognizer, word entries are defined in the vocabulary by their phoneme sequence or by a sequence of states.

Pronunciation variants can, in the case of Sayln systems, be created by the addition of noise to the speech data. Another way of creating variants is to modify the phoneme or state sequence obtained. This can be done with the aid of random factors but also with user-specific information, for example a confusion matrix from the last recognition run. A confusion matrix can be created for example by a second recognition run with phonemes.

Using TypeIn the phoneme sequence is deduced from the autographic notation. With the assignment of graphemes to phonemes statistical methods are known which in addition to the probable phoneme sequence also deliver alternative phoneme sequences. The use of neural networks can serve as an example here.

The assignment can also be undertaken in this case by taking account of a relevant language. For example the name “Martin” is pronounced differently in German and in French and therefore two different phoneme sequences are produced. Naturally the state sequences as with Sayln systems, can also be generated through random factors and user-dependent information.

### EXAMPLE 1

“Herr Meier” is accepted as a new German entry into the vocabulary.

Using Typeln the following (German) canonic phoneme sequences are determined:

Original 1: /h E r m aI 6/

The variants can appear as follows. It is assumed that overall five vocabulary entries correspond to the maximum permissible memory requirement:

variant 1.1: / h E r m aI 6/

variant 1.2: / h E r m aI er/

Variant 1.3: / h 6 m aI 6/

Variant 1.4: / h e r m aI e 6/

Selection or determination of the confidences of the variants

Herr Meier has been called 10 times by voice command. The five variants are referenced as follows, which corresponds to the boolean confidence already mentioned:

| Pronunciation variants | #Referencings | ΣConfidence |
|---|---|---|
| Original 1: | 4 | 4 |
| Variant 1.1: | 0 | 0 |
| Variant 1.2: | 6 | 6 |
| Variant 1.3: | 0 | 0 |
| Variant 1.4:, | 0 | 0 |

In the adaptations step which now follows all variants with the confidence 0 are deleted. The vocabulary thus only still contains the variants “Original 1” and “Variant 1.2”.

Original 1: / h E r m aI 6/

Variant 1.2: / h E r m aI er/

The vocabulary is thus reduced in size by more than a half. This means that the load imposed on the processor for speech recognition (search) is reduced by the same proportion. Simultaneously the danger of this command being confused with others is reduced.

Since the canonic variant “Original 1” is still present, speaker independence is maintained for subsequent recognition runs.

### EXAMPLE 2

The name “Frau Martin” is now added to the vocabulary in example 1 by means of the phoneme-based Sayln system. The phoneme sequences determined are as follows:

Original 2: / f r aU m a r t e-./

The variants for “Frau Martin” appear as follows:

Variant 2.1: / f r aU m A r t In/

Variant 2.2: / f r aU m A t n/

The vocabulary now contains the following entries:

Original 1: / h E r m aI 6/

Variant 1.2: / h E r m aI er/

Original 2: / f r aU m a r t e-/

Variant 2.1: / f r aU m A r t I n/

Variant 2.2: / f r aU m A t n/

Selection or determination of the confidences of the variants

Herr Meier is called three times, Frau Martin five times by voice command. The five variants are evaluated with confidences as follows. In this case a criterion is now used, that is a degree of confidence which for each variant allows information about the reliability of the spoken expression:

| Pronunciation variants | #Referencings | ΣConfidence |
|---|---|---|
| Original 1: | 2 | 100 |
| Variant 1.2: | 1 | 30 |
| Original 2: | 3 | 60 |
| Variant 2.1: | 1 | 10 |
| Variant 2.2: | 1 | 20 |

In the adaptation step which now follows, all variants are deleted which have a confidence of less than 25. The vocabulary thus only still contains the variants “Original 1” and “Variant “2.2” and “Original 2”.

Original 1: / h E r m aI 6/

Variant 1.2: / h E r m aI er/

Original 2: / f r aU m a r t e-/

There are now 2 free entries available again for further pronunciation variants or new words.

It should be understood that various changes and modifications to the presently preferred embodiments described herein will be apparent to those skilled in the art. Such changes and modifications can be made without departing from the spirit and scope of the present disclosure and without diminishing its intended advantages. It is therefore intended that such changes and modifications be covered by the appended claims.

1-12. (canceled)

13. A method for speech recognition, comprising:
determining a number of pronunciation variants that are available for a word;
generating a number of pronunciation variants if no available variants are determined; and
registering which of the pronunciation variants of the word is detected via a recognition process, wherein after a number of recognition processes, an analysis of the frequency of the recognition of the individual pronunciation variants is undertaken to determine the most frequent and least frequent variants recognized in the registering step.

14. The method in accordance with claim 13, wherein the pronunciation variants are generated by one of phoneme replacement, phoneme deletion and phoneme insertion.

15. The method in accordance with claim 13, wherein the pronunciation variants are generated for different languages.

16. The method in accordance with claim 13, wherein the pronunciation variants are generated by the addition of noise.

17. The method in accordance with claim 13, wherein one of the pronunciation variants, especially after a recognition process, is generated as a result of an expression recognized as the word.

18. The method in accordance with claim 13, wherein for a number of words, a maximum permitted number of pronunciation variants is specified.

19. The method in accordance with claim 13, wherein on the basis of the analysis of the frequency of the detection of the individual pronunciation variants, the least frequent variants recognized in the registering step are deleted.

20. The method in accordance with claim 19, wherein the stored pronunciation variants are reduced in accordance with the deleted variants.

21. The method in accordance with claim 13, wherein a confidence value is assigned to each variant, according to the frequency, and wherein the pronunciation variants are deleted for which the confidence lies below a threshold value.

22. The method in accordance with claim 20, wherein the canonic pronunciation variants are not deleted.

23. A computer readable storage medium containing a set of instructions for a processor having a user interface, the set of instructions comprising:
determining a number of pronunciation variants that are available for a word;
generating a number of pronunciation variants if no available variants are determined; and
registering which of the pronunciation variants of the word is detected via a recognition process, wherein after a number of recognition processes, an analysis of the frequency of the recognition of the individual pronunciation variants is undertaken to determine the most frequent and least frequent variants recognized in the registering step.

24. The computer readable storage medium of claim 23, wherein the pronunciation variants are generated by one of phoneme replacement, phoneme deletion and phoneme insertion.

25. The computer readable storage medium of claim 23, wherein the pronunciation variants are generated for different languages.

26. The computer readable storage medium of claim 23, wherein the pronunciation variants are generated by the addition of noise.

27. The computer readable storage medium of claim 23, wherein one of the pronunciation variants, especially after a recognition process, is generated as a result of an expression recognized as the word.

28. The computer readable storage medium of claim 23, wherein for a number of words, a maximum permitted number of pronunciation variants is specified.

29. The computer readable storage medium of claim 23, wherein on the basis of the analysis of the frequency of the detection of the individual pronunciation variants, the least frequent variants recognized in the registering step are deleted.

30. The computer readable storage medium of claim 29, wherein the stored pronunciation variants are reduced in accordance with the deleted variants.

31. The computer readable storage medium of claim 23, wherein a confidence value is assigned to each variant, according to the frequency, and wherein the pronunciation variants are deleted for which the confidence lies below a threshold value.

32. The computer readable storage medium of claim 30, wherein the canonic pronunciation variants are not deleted.
